(19) United States
(12) Patent Application Publication
(10) Pub. No.: US 2023/0034911 A1
(43) Pub. Date: Feb. 2, 2023

(54) SYSTEM AND METHOD FOR PROVIDING AN INTELLIGENT LEARNING EXPERIENCE

(71) Applicant: Microsoft Technology Licensing, LLC, Redmond, WA (US)

(72) Inventors: Jan-Ove Almli KARLBERG, Tromsø (NO); Torbjørn HELVIK, Oslo (NO); Jon MELING, Tromsø (NO)

(73) Assignee: Microsoft Technology Licensing, LLC, Redmond, WA (US)

(21) Appl. No.: 17/391,438

(22) Filed: Aug. 2, 2021

(51) Int. Cl. G09B 5/02; G06N 5/02; G06F 16/2455

(52) U.S. Cl. CPC G09B 5/02; G06N 5/022; G06F 16/2455

(57) ABSTRACT

A method and system for creating a learning graph may include accessing a general knowledge graph, the general knowledge graph including a plurality of items of information about a plurality of general knowledge topics, extracting a plurality of learning topics, the plurality of learning topics being topics associated with a desired learning curriculum, identifying associations between one or more of the plurality of learning topics and one or more of the plurality of items of information in the general knowledge graph, upon identifying the associations, utilizing the associations to create a learning graph based on at least one of the one or more of the plurality of learning topics, the one or more of the plurality of items of information and the associations between them, the learning graph being a learning knowledge visualization graph, and transmitting the learning graph to a learning application for use in providing the desired learning curriculum.

### BACKGROUND

In today's knowledge-based economies, where employees' training and knowledge contribute significantly to an entity's success, providing appropriate training to employees is an important and often labor and/or cost intensive task. For example, many enterprises retain the services of multiple individuals to prepare and provide training and new learning opportunities to their employees. However, in person learning experiences are often time consuming, costly and not adaptable to individual employee's needs.

To address this issue, some electronic learning systems have been developed that provide electronic access to various course contents. While these systems provide the learner with some flexibility to choose desired topics and move at their own pace, currently available learning systems often require a person to prepare the learning materials. This is still time and labor intensive. Furthermore, currently available learning systems often provide a one-dimensional learning experience which is not adaptable or targeted to a user's needs.

Hence, there is a need for systems and methods of providing an intelligent learning experience.

### SUMMARY

In one general aspect, the instant disclosure describes a data processing system having a processor and a memory in communication with the processor wherein the memory stores executable instructions that, when executed by the processor, cause the data processing system to perform multiple functions. The functions may include accessing a general knowledge graph, the general knowledge graph including a plurality of items of information about a plurality of general knowledge topics, extracting a plurality of learning topics, the plurality of learning topics being topics associated with a desired learning curriculum, identifying associations between one or more of the plurality of learning topics and one or more of the plurality of items of information in the general knowledge graph, upon identifying the associations, utilizing the associations to create a learning graph based on at least one of the one or more of the plurality of learning topics, the one or more of the plurality of items of information and the associations between them, the learning graph being a learning knowledge visualization graph, and transmitting the learning graph to a learning application for use in providing the desired learning curriculum.

In yet another general aspect, the instant disclosure describes a method for creating a learning graph. The method may include accessing a general knowledge graph, the general knowledge graph including a plurality of items of information about a plurality of general knowledge topics, extracting a plurality of learning topics, the plurality of learning topics being topics associated with a desired learning curriculum, identifying associations between one or more of the plurality of learning topics and one or more of the plurality of items of information in the general knowledge graph, upon identifying the associations, utilizing the associations to create the learning graph based on at least one of the one or more of the plurality of learning topics, the one or more of the plurality of items of information and the associations between them, the learning graph being a learning knowledge visualization graph, and transmitting the learning graph to a learning application for use in providing the desired learning curriculum.

In a further general aspect, the instant disclosure describes a non-transitory computer readable medium on which are stored instructions that when executed cause a programmable device to access a general knowledge graph, the general knowledge graph including a plurality of items of information about a plurality of general knowledge topics, extract a plurality of learning topics, the plurality of learning topics being topics associated with a desired learning curriculum, identify associations between one or more of the plurality of learning topics and one or more of the plurality of items of information in the general knowledge graph, upon identifying the associations, utilize the associations to create a learning graph based on at least one of the one or more of the plurality of learning topics, the one or more of the plurality of items of information and the associations between them, the learning graph being a learning knowledge visualization graph, and transmit the learning graph to a learning application for use in providing the desired learning curriculum.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example of a system upon which aspects of this disclosure may be implemented.

FIG. 2 is an example of knowledge visualization graph containing items of information from a general taxonomy and an entity taxonomy.

FIG. 3 is a flow diagram showing an example of a method for creating a learning curriculum.

FIGS. 4A-4B depict example graphical user interface (GUI) screens of an example learning curriculum.

FIG. 5 is a block diagram illustrating an example of software architecture, various portions of which may be used in conjunction with various hardware architectures herein described.

FIG. 6 is a block diagram illustrating components of an example of a machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

With the ever-changing world of science and technology, providing employees or other individuals associated with an entity (e.g., enterprises, educational entities, and the like) with an up-to-date training and learning experience is an important task for most entities. However, with the vast amount of information available both within and outside of an entity, it is often difficult to determine how to provide an entity-specific learning experience that is efficient, adaptable and targeted. For example, most entities have a variety of information about their specific entity which can be categorized into different topics (e.g., different departments, services/products provided, core values, employee guidelines, and the like).

Some of the entity-specific topics may relate to knowledge that is publicly available outside of the enterprise. For example, information about the services and/or products offered by an enterprise may be available outside of the enterprise in a well-organized manner. As such, instead of utilizing inside information which may require organization and/or preparation of training materials, it may be more efficient to access publicly available resources to provide a comprehensive learning experience to a new employee of the enterprise. However, there may be additional information about the enterprise that is not publicly available. A comprehensive training program would require examining the inside information as well as the information publicly available. However, determining the type of information that is publicly available, how the information is associated with entity-specific knowledge, and how to incorporate the entity-specific knowledge into the publicly available knowledge to provide an efficient learning experience is often a time and labor-intensive effort and as such can become costly when done manually. This is particularly the case since both publicly available and entity-specific knowledge can continually change. As such, there exists a technical problem of efficiently utilizing publicly available and entity-specific knowledge to provide a comprehensive learning experience.

Moreover, currently available electronic learning systems provide a linear learning curriculum. The learner in such a system may be able to choose a topic. However, once a topic is selected, a sequence of learning experiences (e.g., courses, sessions, etc.) is provided without further determination. This often leads to a learning experience which is one-dimensional, non-flexible and impersonal. Thus, there exists another technical problem of lack of an electronic learning system that provides adaptable, targeted, and intelligent learning and enables the user to select a learning path while providing alternative learning options.

To address these technical problems and more, in an example, this description provides a technical solution for automatically creating a comprehensive and targeted learning experience from information available in a general taxonomy and information present in an entity-specific taxonomy. This may be done by first examining an existing general taxonomy of information and examining an entity-specific taxonomy of information to determine how the entity-specific information fits within the existing taxonomy of information. This may be achieved by performing graph walks through taxonomy knowledge graphs associated with the existing taxonomy of information and/or the entity-specific taxonomy. Based on how the entity-specific information fits within the existing taxonomy of information, a learning graph may be automatically created. The learning graph may be presented to the user via a user interace (UI) displaying a visualization graph from which the user can select one or more topics. Once the user makes a selection, a learning path may be created based on the user's selection and the graph walks included in the learning graph. As more selections are made, additional graph walks may be made based on the user's selections to create a personalized learning path for the user. In some implementations, the user is provided with information about paths that were not taken (e.g., learning topics that were not selected), such that the user is informed of the overall learning curriculum and can make deviations and corrections if needed. Thus, a comprehensive learning curriculum which takes into account both existing public knowledge and entity-specific knowledge can be automatically created. The learning curriculum enables users to easily navigate various learning topics and gain an understanding of connections between items of information displayed by providing an adaptable knowledge network visualization graph.

As will be understood by persons of skill in the art upon reading this disclosure, benefits and advantages provided by such implementations can include, but are not limited to, a technical solution to the technical problem of lack of mechanisms for automatically creating an electronic learning system that takes into account both existing general knowledge and entity-specific knowledge and provides an intelligent and adaptable learning curriculum. The technical solutions may automatically provide a learning curriculum from existing general knowledge and entity-specific knowledge, provide the learning curriculum via knowledge network visualization graphs, and enable users to quickly and accurately navigate and gain information from the knowledge network visualization graphs. Furthermore, the technical solutions may create and personalize learning paths based on a user's selection, while providing the user with information about paths that were not taken. The benefits provided by these technology-based solutions yield efficiently created, comprehensive, personalized and user-friendly electronic learning mechanisms.

As used herein, the terms “item of information,” may refer to a unit of information such as a concept, project, topic, resource, person and the like, which may be related to other items of information. Furthermore, as used herein, the term “relationship” or “connection” may refer to an association between two items of information. The term “user” may refer to a person who utilizes a computing device. Moreover, the term “knowledge network visualization graph” may be used to refer to a graph that displays relationships between different items of information. Additionally, the term “taxonomy” may be used to refer to multiple items of information which are categorized and classified into different groups.

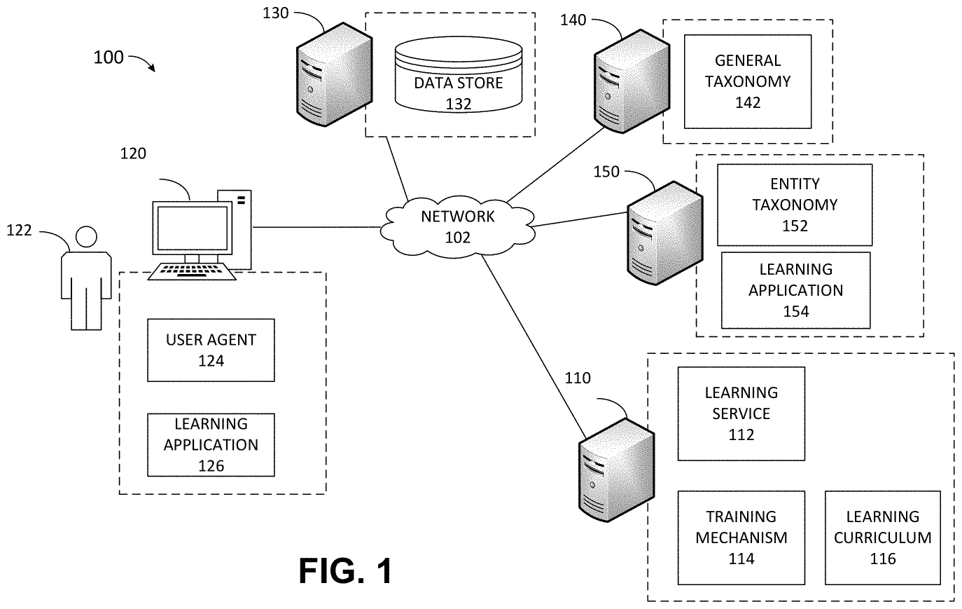

FIG. 1 illustrates an example system 100, upon which aspects of this disclosure may be implemented. The system 100 may include a server 110, server 130, server 140, server 150 and a client device 120. Each of the servers 110, 130, 140 and 150 may operate as a shared resource server located at an enterprise accessible by various computer client devices. The server 150 may operate as a shared resource server accessible by computer devices such as the client device 120. The server 110 may also operate as a cloud-based server for offering global learning services to one or more entities. The server 150, on the other hand, may operate as a cloud-based server for offering enterprise-specific learning services to one or more users utilizing computer devices such as the client device 120. Although shown as one server, each of the servers 110, 130, 140 and 150 may represent multiple servers for performing various different operations or storing different types of data.

The server 140 may be a storage server which stores a general taxonomy 142. The general taxonomy 142 may contain data about various items of information that are categorized into different groups. The general taxonomy 142 may be a publicly available taxonomy (e.g., Wikipedia) and may be a general knowledge graph. In some implementations, the general taxonomy 142 may be created from general information and/or knowledge available either publicly (e.g., via the Internet) and/or available via one or more additional resources (e.g., libraries, universities, enterprises having taxonomies on general topics, etc.). An example of a general taxonomy is Microsoft® Satori graph which extracts data from unstructured information on the web to create a structured database containing various categories of knowledge such as people, places, enterprises, things, and the relationships between one or more of them.

The server 150 may be a storage server associated with an entity (e.g., an enterprise) for storing an entity taxonomy 152 and a learning application 154. The entity taxonomy 152 may be a knowledge graph associated with a specific entity. As such, the entity taxonomy 152 may contain data about entity-specific knowledge that has been categorized into one or more distinct classifications. For example, the entity taxonomy 152 may function as a knowledge graph formed by extracting entity-specific information from an entity's storage servers and/or from other resources such as publicly available repositories. The entity-specific information for an enterprise may include information about various departments in the enterprise, information about products and/or services offered by the enterprise, employee guidelines, and the like. The entity-specific information may be categorized into different classifications to create a knowledge graph forming the entity taxonomy 152. In some implementations, the entity taxonomy 152 is created as part of the process of creating a learning curriculum. This may be done by the learning service 112 or by another element designed for creating taxonomies.

The learning application 154 may be an electronic learning software program that utilizes the learning curriculum 116 to provide a comprehensive learning experience, as further discussed below. The learning application 154 may be a cloud-based application for providing a learning experience to computer users such as user 122 via the client device 120. Although shown as being stored in the server 150, the learning application 154 may be stored in a different server.

The server 110 may include and/or execute a learning service 112, training mechanism 114, and learning curriculum 116. The learning service 112 may operate as the backend engine for performing taxonomy analysis, determining how knowledge from various taxonomies should be combined and creating a learning curriculum such as the learning curriculum 116 based on its determinations. The learning service 112 may access one or more data sets and utilize one or more machine-learning (ML) models to identify relationships between various items of information stored in the data sets. The relationships may be determined based on a number of factors and by using various mechanisms, as further discussed below.

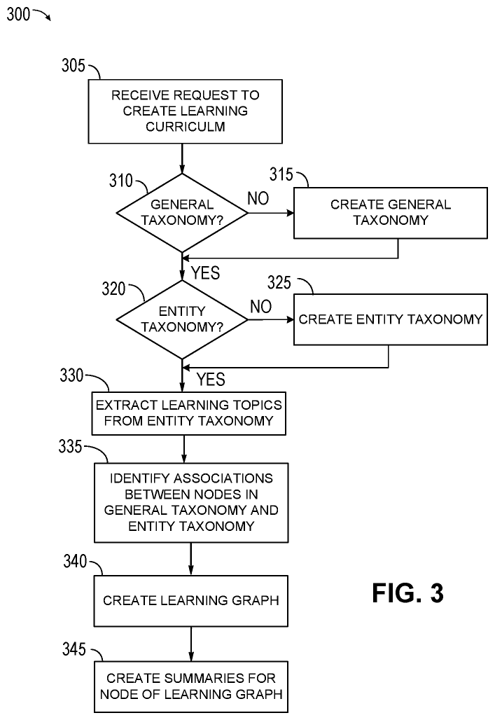

In some implementations, the learning service 112 gains access to the general taxonomy 142 to obtain information about publicly and/or generally available items of information that may relate to an entity for which a learning curriculum is being created. The learning service 112 may also access the entity taxonomy 152 to obtain entity-specific information that may need to be included in the learning curriculum. The learning service 112 may then identify relationships between the entity-specific information and items of information available in the general taxonomy 142. This may be done by utilizing a semantic search index, as discussed in more detail below, with respect to FIG. 3.

Based on the relationships identified, the learning service 112 may then create the learning curriculum 116 for the entity. The learning curriculum 116 may be a learning graph that associates various items of information which each other to create a knowledge graph specifically created for teaching a user about specific topics (e.g., topics related to an entity). Once created, the learning curriculum 116 may be transmitted by the server 110 to the server 150 for use by the learning application 154. In some implementations, the learning curriculum 116 may be transmitted in batches while being created and may be stored in the server 150 in addition to or instead of the server 110.

One or more ML models implemented by the learning service 112 may be trained by the training mechanism 114. The training mechanism 114 may use training data sets stored in the data store 132 to provide initial and ongoing training for each of the models. Alternatively or additionally, the training mechanism 114 may use training data sets from elsewhere. This may include data such as knowledge from general taxonomy 142 (e.g., public repositories such as Internet sources), knowledge from enterprise sources such as the entity e taxonomy 152, or knowledge from other pre-trained mechanisms. In one implementation, the training mechanism 114 uses labeled training data to train one or more of the models via deep neural network(s) or other types of ML models. The initial training may be performed in an offline stage. Additionally and/or alternatively, the one or more ML models may be trained using batch learning.

As a general matter, the methods and systems described herein may include, or otherwise make use of, an ML model to identify relationships between items of information in various taxonomies (e.g., general taxonomy 142 or entity taxonomy 152). ML generally includes various algorithms that a computer automatically builds and improves over time. The foundation of these algorithms is generally built on mathematics and statistics that can be employed to predict events, classify entities, diagnose problems, and model function approximations. As an example, a system can be trained using data generated by an ML model in order to identify patterns in users' learning activities, determine associations between items of information, and/or identify how items of information can be fit together to create a learning curriculum. Such training may be made following the accumulation, review, and/or analysis of data (e.g., user data) over time. Such data is configured to provide the ML algorithm (MLA) with an initial or ongoing training set. In addition, in some implementations, a user device can be configured to transmit data captured locally during use of relevant application(s) to a local or remote ML algorithm and provide supplemental training data that can serve to fine-tune or increase the effectiveness of the MLA. The supplemental data can also be used to improve the training set for future application versions or updates to the current application.

In different implementations, a training system may be used that includes an initial ML model (which may be referred to as an “ML model trainer”) configured to generate a subsequent trained ML model from training data obtained from a training data repository or from device-generated data. The generation of both the initial and subsequent trained ML model may be referred to as “training” or “learning.” The training system may include and/or have access to substantial computation resources for training, such as a cloud, including many computer server systems adapted for machine learning training. In some implementations, the ML model trainer is configured to automatically generate multiple different ML models from the same or similar training data for comparison. For example, different underlying MLAs, such as, but not limited to, decision trees, random decision forests, neural networks, deep learning (for example, convolutional neural networks), support vector machines, regression (for example, support vector regression, Bayesian linear regression, or Gaussian process regression) may be trained. As another example, size or complexity of a model may be varied between different ML models, such as a maximum depth for decision trees, or a number and/or size of hidden layers in a convolutional neural network. Moreover, different training approaches may be used for training different ML models, such as, but not limited to, selection of training, validation, and test sets of training data, ordering and/or weighting of training data items, or numbers of training iterations. One or more of the resulting multiple trained ML models may be selected based on factors such as, but not limited to, accuracy, computational efficiency, and/or power efficiency. In some implementations, a single trained ML model may be produced.

The training data may be continually updated, and one or more of the ML models used by the system can be revised or regenerated to reflect the updates to the training data. Over time, the training system (whether stored remotely, locally, or both) can be configured to receive and accumulate more training data items, thereby increasing the amount and variety of training data available for ML model training, resulting in increased accuracy, effectiveness, and robustness of trained ML models.

In collecting, storing, using and/or displaying any user data, care must be taken to comply with privacy guidelines and regulations. For example, options may be provided to seek consent (e.g., opt-in) from users for collection and use of user data, to enable users to opt-out of data collection, and/or to allow users to view and/or correct collected data.

The server 110 may be connected to (e.g., via a network 102) or include a storage server 130 containing a data store 132. The data store 132 may function as a repository in which one or more data sets containing data about various items of information and/or their relationships with one another is stored. In one implementation, data store 132 may also include one or more data sets containing training data for training the ML models used in determining the relationships between different items of information. For example, the data store 132 may include user data collected from various user's use of a learning application to update one or more of the ML models.

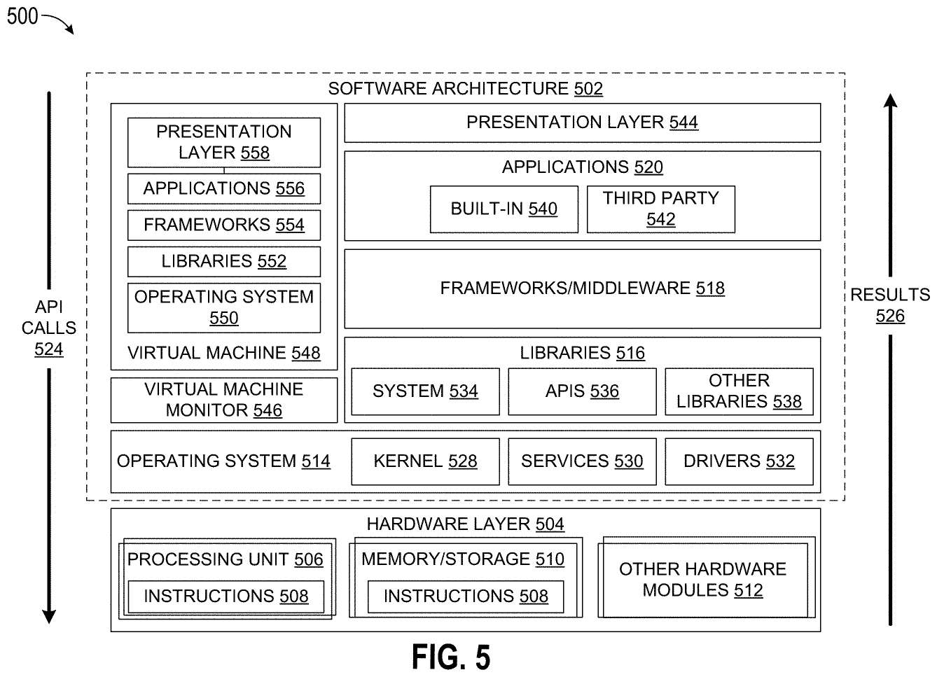

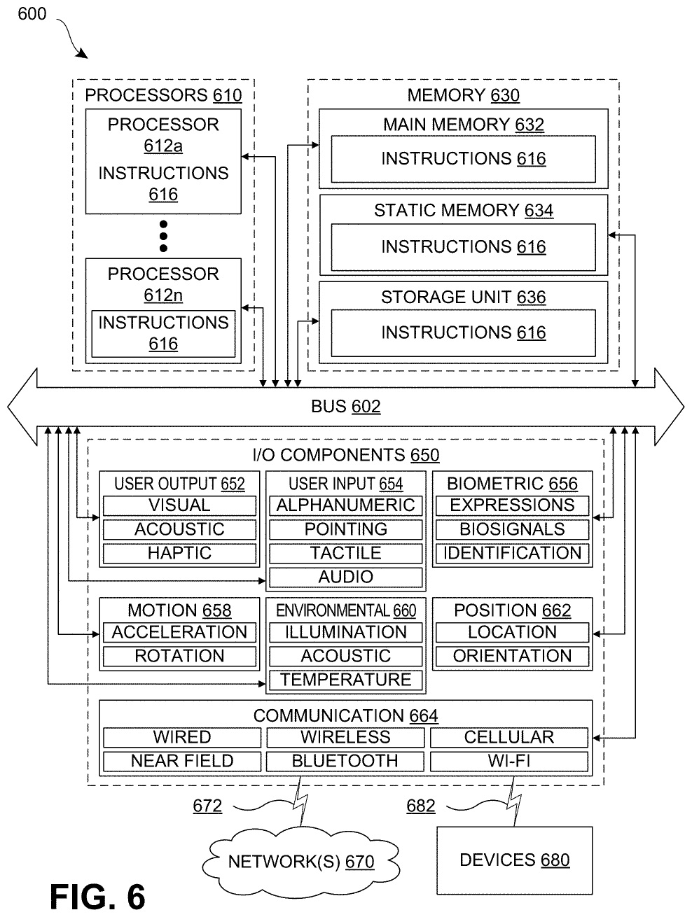

Various elements of the system 100 may be connected to each other via the network 102. The network 102 may be a wired or wireless network(s) or a combination of wired and wireless networks. The client device 120 may be a personal or handheld computing device having or being connected to input/output elements that enable the user 122 to interact with content such as the learning application 126 or the user agent 124. Examples of suitable client devices 120 include, but are not limited to, personal computers, desktop computers, laptop computers, mobile telephones; smart phones; tablets; phablets; smart watches; wearable computers; gaming devices/computers; televisions; head-mounted display devices and the like. The internal hardware structure of a client device is discussed in greater detail with reference to FIGS. 5 and 6.

The client device 120 may include the learning application 126 and the user agent 124. The learning application 126 may be a local version of the learning application 154, and as such may be a learning application executed on the client device 120 that enables the user to have a learning experience using one or more of the technical solutions disclosed herein. In some implementations, the learning application 126 provides a UI that allows the user to interact with a learning curriculum such as the learning curriculum 116. Access to the learning curriculum 116 may be provided to the learning application 126 via the server 110 and/or the server 150. The learning application 126 may display the learning curriculum 116 via one or more knowledge visualization graphs.

In some implementations, the learning experience may be provided by an online service accessed via the user agent 124, such as a browser, executing on the client device 120. The user agent 124 may provide a UI that allows the user 122 to interact with the learning application 154 via a webpage. The user agent 124 may access the webpage or online service via the network 102.

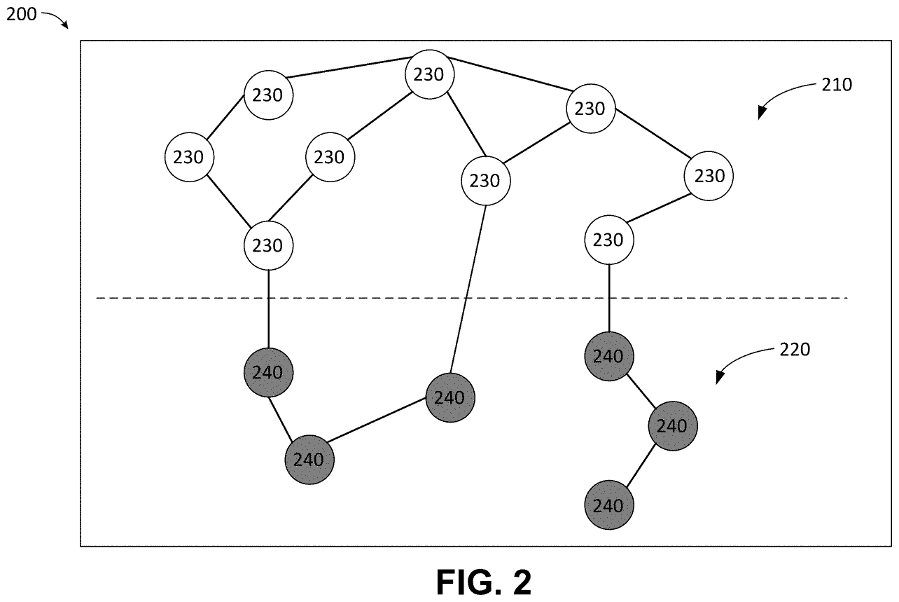

FIG. 2 shows an example knowledge visualization graph 200 containing items of information from a general taxonomy and an entity taxonomy. In the knowledge visual graph 200, a portion 210 displays nodes 230 of a general taxonomy. Each of the nodes 230 represent items of information associated with a specific classification provided by the general taxonomy. As illustrated, the general taxonomy may include multiple nodes, each of which may have relationships with one or more other nodes 230 of the general taxonomy. Although, only a few nodes and relationships are illustrated in the portion 210, a real-world general taxonomy may include thousands of nodes having complex relationships with numerous other nodes.

The knowledge visual graph 200 also includes a portion 220 displaying nodes 240 of an entity taxonomy. Each of the nodes 240 may represent items of information associated with a classification provided by an entity taxonomy. Like the nodes 230, each of the nodes 240 may have relationships with one or more other nodes 240. As part of the process of developing a learning curriculum, relationships between nodes 240 of the entity taxonomy and nodes 230 of the general taxonomy may be identified to determine how each entity-specific node 240 fits within the general taxonomy. For example, there may be some entity-specific topics that are directly related to topics identified in the general taxonomy. Other topics of the nodes 240 may be classified as subcategories of one or more nodes 230. Once relationships have been examined and identified, a combined knowledge visual graph, such as the visual graph 200 may be created that includes nodes from both the general taxonomy and the entity taxonomy. The combined knowledge visual graph may function as a fabric of generalized knowledge that is mapped to topics within the organization.

FIG. 3 is a flow diagram depicting an exemplary method 300 for creating a learning curriculum. In an example, one or more steps of method 300 may be performed by a learning service (e.g., learning service 112 of FIG. 1), a training mechanism user agent (e.g., training mechanism 114 of FIG. 1) and/or another element.

At 305, method 300 may begin by receiving a request to create a learning curriculum. The request may be received from an entity requiring a new learning curriculum. For example, the request may be received from an enterprise requiring a learning curriculum for new employees. In another example, the request may be received via an educational entity (e.g., a school or university) requiring an electronic learning curriculum for a specific educational topic. In some implementations, the request includes information about the type of learning curriculum required (e.g., training for new employees, topic specific curriculum, etc.). When information about the specific type of training required is provided, that information may be taken into account when creating and/or examining an entity taxonomy, as further discussed below.

In some implementations, the request also includes information about entity-specific information (e.g., an existing entity taxonomy or an address at which entity-specific information can be accessed for creating an entity taxonomy). Furthermore, the request may contain information about a specific general taxonomy (e.g., knowledge graph) that should be used to create the learning curriculum. The request may be transmitted from an administrator associated with the entity automatically (e.g., via a website) or may be made via a message to an administrator of the learning service (e.g., an email to a team associated with the learning service). In some implementations, the learning service may be provided as a local application that can be acquired by an entity and executed on their local computer systems.

Once a request for creating a learning curriculum has been received, method 300 may proceed to determine if an existing general taxonomy (e.g., general knowledge graph) is available for use in creating the learning curriculum, at 310. As explained above, the general taxonomy may be a general knowledge graph that includes general knowledge about a multitude of topics. In some implementations, the general knowledge graph is one that is available publicly. In other implementations, the general knowledge graph may be provided by an entity, for example, for internal use. If it is determined that a general taxonomy is not available (NO at step 310), method 300 may proceed to create a general taxonomy, at 315, by using one or more mechanisms known in the art.

When it is determined that a general taxonomy is available for use (YES at step 310) or after creating a general taxonomy, method 300 may proceed to determine if an entity taxonomy that can be used in creating the desired learning curriculum exists, at 320. Upon determining that an entity taxonomy is not available for use (NO at step 320), method 300 may proceed to create an entity taxonomy from entity-specific information, at 325. This may be done by utilizing one or more mechanisms known in the art for creating taxonomies.

When it is determined that an existing entity taxonomy is available for use (YES at step 320) or after creating the entity taxonomy, method 300 may proceed to extract learning topics from the entity taxonomy, at 335. This may involve identifying which one of the topics associated with the entity taxonomy relate to the desired learning curriculum and identifying nodes of the entity taxonomy that relate to those topics. Moreover, in some implementations, the steps of determining if an entity taxonomy exists or creating an entity taxonomy may be replaced with accessing a set of known desired learning topics and information associated with those learning topics. In an example, the desired learning topics and documents associated with those learning topics are provided to the learning service either as part of the request or separately.

Once the desired learning topics have been extracted, method 300 may proceed to examine the general taxonomy and the entity taxonomy to identify associations between nodes in the general taxonomy and the entity taxonomy, at 330. This may be performed via a variety of known mechanisms for identifying associations between knowledge graph nodes. In an example, identifying associations between nodes in the general taxonomy and the entity taxonomy is done by utilizing a semantic search index. To achieve this, first, one or more of the general taxonomy nodes may be indexed. This may involve indexing information (e.g., titles, descriptions, file names, keywords, and/or other relevant meta data) about items of information associated with nodes of the general taxonomy. Once required nodes of the general taxonomy are indexed in this manner, a mechanism may be used to examine each set of topics (e.g., each node) of the entity taxonomy, extract some information about each node and make one or more queries towards the semantic search index with the extracted information. For example, queries may be created that contain search strings built with information extracted from the entity taxonomy nodes (e.g., titles, descriptions, file names, keywords, and/or other relevant metadata about items of information associated with each node).

Once a query is made, if a node in the general taxonomy is associated with the query, information about the node may be provided as a query result. The query results may then be examined to determine if a query result shows an association between the query and the semantic search index. In some implementations, a mechanism is used to measure a degree of association between the search query and the query result (e.g., a taxonomy node). This may be done by utilizing an ML model that provides an association score. Alternatively, the degree of association may be provided by utilizing other mechanisms such as a term frequency—inverse document frequency (TF-IDF) algorithm. When it is determined that the degree of association between the search query and the query result meets a required threshold (e.g., exceeds a required score), then the query result (e.g., general taxonomy node) may be identified as being associated with the entity taxonomy node based on which the search query was built. This process may be repeated for more nodes of the entity taxonomy (e.g., all nodes of the entity taxonomy) until one or more nodes of the general taxonomy that are associated with the entity taxonomy nodes are identified.

In scenarios where the request for creating a learning curriculum relates to a specific type of curriculum, nodes of the entity taxonomy that are related to the specific type of curriculum may first be identified (e.g., nodes related to a specific learning topic) and then only those nodes may be used to run search queries against the semantic search index. In this manner, nodes of the general taxonomy that are related to specific nodes of the entity taxonomy may be identified and used to create the learning graph.

Once nodes of the general taxonomy that are associated with the entity taxonomy nodes are identified, the identified general taxonomy nodes and entity taxonomy nodes may be combined to create a learning graph, at 340. This may involve incorporating the general taxonomy nodes that are associated with the entity taxonomy nodes into the entity taxonomy to create a fabric of generalized knowledge that is mapped to topics within the entity. This fabric may be utilized to create a knowledge visualization graph that forms the learning graph.

In some implementations, once the learning graph is created, information about various nodes of the learning graph may be used to create a summary for one or more nodes of the learning graph, at 345. This may involve accessing contents of documents and/or information (e.g., titles, descriptions, metadata and the like) associated with one or more nodes of the learning graph to extract information that can be used to create a summary for the nodes (e.g., each node of the learning graph). For example, if a node of the learning graph is created based on information in a Word document, content of the Word document may be accessed to create a summary for the node. In an example, if the document includes an abstract or another form of summary, the summary provided may be used. In another example, one or more natural language processing algorithms may be used to extract information and create a summary for each node. The summaries together with the learning graph may form the basis for a learning curriculum that is used by a learning application to provide an adaptable and comprehensive learning experience.

In some implementations, the learning curriculum is updated periodically to ensure any new information that has become available since the last update is considered. For example, the learning curriculum may be updated based on a predetermined schedule (e.g., weekly or monthly). In another example, a periodic search may be conducted to determine if information associated with one or more nodes of the learning graph has been changed since the last update, and if a change is detected, the learning graph may be updated to account for the changed information. In another example, once a new topic is added to an entity taxonomy, a search query based on the new topic is executed against the semantic search index to determine if the new topic is associated with any nodes of the general taxonomy. If an association is identified that satisfies a required degree of association, the new topic is added to the learning graph.

In some implementations, when creating the learning graph, information about access rights associated with each item of information in the learning graph may be included in the learning graph. This may be needed when the entity taxonomy includes information that cannot be made available to certain users and/or services. For example, some entity-specific information may be confidential and/or private and as such may have specific access rights (e.g., only available to certain teams of an organization). If such information is included in the learning graph, the access rights associated with the information may be provided in the learning graph. The learning application may then examine the user's credentials to make sure they have the required access rights before enabling the user to access the information.

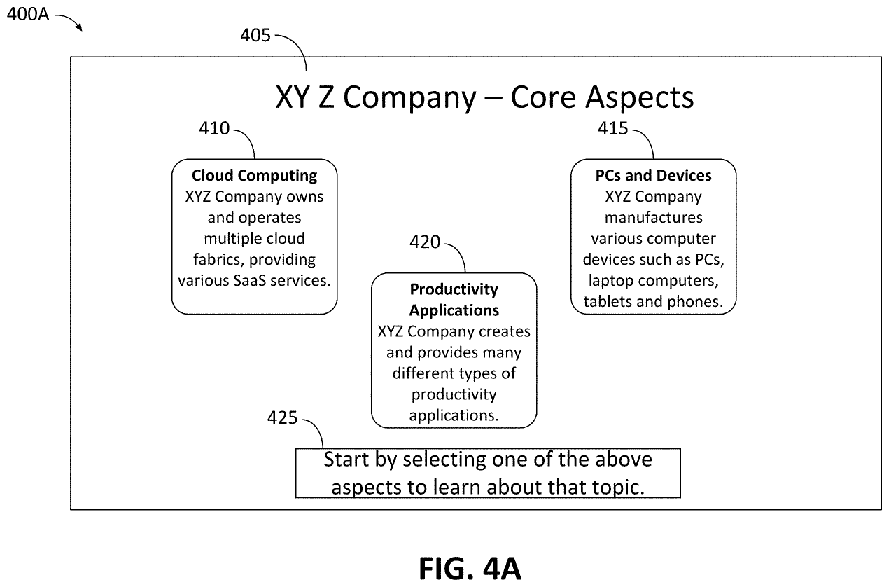

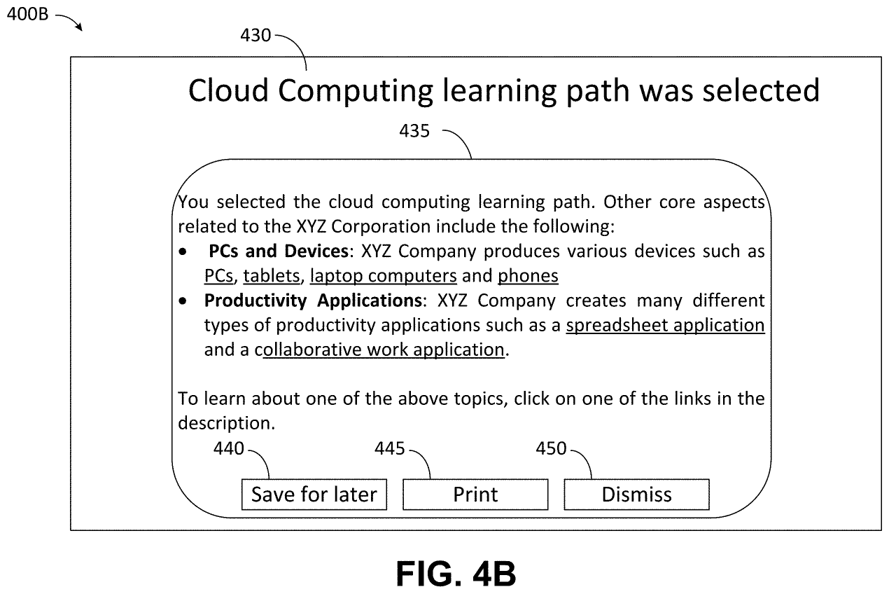

FIGS. 4A-4B depict example GUI screens of an example learning curriculum. FIG. 4A depicts an example GUI screen 400A displaying a starting UI screen of an example learning curriculum. As depicted, the GUI screen 400A may include a title 405 which provides a brief description for the nodes provided on the screen. Since the screen 400A is the starting screen of the example learning curriculum, it includes the name of the entity for which training is being provided, as well as a description of the topics included in the screen 400A. Thus, the title 405 reads “XYZ Company—Core Aspects” to inform the user that the training is related to the XYZ company and the current screen includes information about core aspects relating to the XYZ company. In some implementations, the title for any screen of the learning application that includes a title is created by the learning application and may be generated based on some general information provided about the learning curriculum (e.g., metadata about the learning curriculum) and/or from information extracted from the learning graph. In alternative implementations, the title is created as part of the process of creating the learning curriculum (e.g., by a learning service) and is included with the learning curriculum provided to the learning application.

The GUI screen 400A may also include various UI elements 410, 415, 420 for providing a visual representation of each topic (e.g., core aspects) in the top level of the learning graph. Each of the UI elements 410, 415, 420 may display a title for the topic as well as a brief description of the topic. The brief description may be created based on information associated with the topic (e.g., from metadata related to documents associated with the topic) and/or from summaries of each topic and may be generated and provided as part of the learning graph. Alternatively, the descriptions may be created by the learning application from information extracted from the learning graph (e.g., from the summaries).

When there is an association between topics visualized by the UI elements of a learning application screen (e.g., 410, 415, and 420), one or more visual cues may be used to depict the associations. For example, solid lines connecting two UI elements may be utilized to show an association between the two topics visualized by the UI elements. As such, the GUI screen 400A may function as a knowledge visualization graph which displays the top-level topics of a knowledge graph (learning graph). The topics visualized by the UI elements 410, 415, and 420 may include topics that provide summary information about the entire learning domain (e.g., enterprise). These core topics could be provided manually (e.g., along with a request for creating a learning curriculum or by an administrator of the learning service) or may be seeded from publicly available information such as web sources and/or a general taxonomy.

In some implementations, the brief descriptions displayed in the UI elements 410, 415, and 420 may be created by first identifying top-level topics associated with each of the core aspects. This may be done by executing a set of short graph walks (e.g., one to two hops) in the top level of the learning graph. Executing a graph walk may involve finding a source node (e.g., an anchor) from which the query starts and following relationships of given types to related nodes in the learning graph. Such queries may follow one or more types of relationships and may go through zero or more intermediary nodes. The short graph walks may be anchored (e.g., seeded) on core aspects of the entity. Information about the nodes accessed during the short graph walks may then be extracted to create brief descriptions for each of the core aspects displayed in the GUI screen 400A. In alternative implementations, the brief description of each core aspect is distilled from the learning summaries. In some implementations, the brief description is structured differently than the summary because the brief description is often limited to one or two sentences while the summary can be multiple sentences long.

The GUI screen 400A may also include a UI element 425 for providing guidance to the user on how to proceed. For example, the UI element 425 provides an explanation that the user can start the learning process by selecting one of the UI elements 410, 415 or 420 to learn about the topic displayed by the UI element. Once the user selects one of the UI elements 410, 415 or 420, a GUI screen displaying information about the selected topic may be presented. In some implementations, if the selected UI element represents a topic which includes multiple subcategories, the subcategories may be displayed in a GUI screen similar to the GUI screen 400A. Selection of one of the subcategories may then result in information being presented about the subcategory and/or display of other categories that fall under the subcategory. In this manner, the user may be able to navigate a chosen learning path by traversing from a top topic to lower-level topics. When selection of a topic results in display of information about the topic, the information may be provided within the GUI screen of the learning application. For example, a document associated with a selected node of the learning graph may be opened directly from within the learning application. Alternatively, content of the document may be extracted, formatted in a desired manner and displayed on a GUI screen of the learning application.

In some implementations, when the user selects a topic on the GUI screen 400A, a summary of non-selected topics is presented to the user. This is depicted in the GUI screen 400B of FIG. 4B which includes a UI element 430 for notifying the user of the path selected and a UI element 435 for providing a summary of the non-selected topics. The UI element 435 may include an indication about the learning path selected before providing the user with a summary of non-selected topics. In some implementations, the summaries presented in the UI element 435 are the topic summaries generated, as discussed above. In alternative implementations, the summaries presented contain a brief description similar to the descriptions provided in the GUI screen 400A.

The summaries provided in the UI element 435 may include links to various topics associated with each non-selected topic. For example, if the topic of PCs and Devices is associated with (e.g., connected via one or two hops in the learning graph) with PCs, tablets, laptop computers and phones, separate links may be provided in the summary for each of those topics. The links may be links to external sources that provide information about the topics. Additionally, or alternatively, the links may take the user to information associated with the node (e.g., for PCs, the user may be presented with information that would have been displayed, had the user selected the PCs and Devices topic, navigated to and selected the PCs node). The length and/or completeness of the summaries and the number of links provided may be set by an administrator. Furthermore, the length of the summaries and/or number of links may be adjustable by the user.

The GUI screen 400B also includes a UI element (button) 440 for choosing the save the summary information for later, a UI element (button) 445 for printing the summary information, and a UI element 450 (button) for dismissing the UI element 435. Once the user selects one of the UI elements 440 or 450, the UI element 435 may be removed and the process of enabling the user to navigate the selected cloud computing learning path may begin. In some implementations, each time the user selects a topic of information in a graph of the learning application, a summary of the non-selected topics is presented in a UI element such as the UI element 435.

When a learning path is exhausted (e.g., there is no next level topic in the learning graph), new topics may be recommended to the user. These topics may be non-selected topics that the user chose to save for later, may be identified based on usage patterns (e.g., users who select topics similar to the user choose to view these other topics) and/or concepts similar or related to the knowledge currently being consumed by the user. The topics identified based on usage patterns may be determined by using one or more ML models. In some implementations, unexpected branches generated in the same manner can also be presented to the user throughout the learning experience.

In this manner, the technical solutions provide a learning curriculum that combines knowledge from a general knowledge graph with entity-specific knowledge graphs to offer a targeted yet comprehensive learning experience. The learning experience may guide the user in navigating the graph by allowing the user to learn about increasingly specialized fields of knowledge with a larger knowledge corpus. The learning curriculum may also provide the user with succinct summaries of the knowledge areas they choose not to pursue at the moment. This results in a learning experience that enables the user to learn about deeper and deeper topics in a learning path, while providing mechanisms for broadening the user's knowledge over time.

FIG. 5 is a block diagram 500 illustrating an example software architecture 502, various portions of which may be used in conjunction with various hardware architectures herein described, which may implement any of the above-described features. FIG. 5 is a non-limiting example of a software architecture and it will be appreciated that many other architectures may be implemented to facilitate the functionality described herein. The software architecture 502 may execute on hardware such as client devices, native application provider, web servers, server clusters, external services, and other servers. A representative hardware layer 504 includes a processing unit 506 and associated executable instructions 508. The executable instructions 508 represent executable instructions of the software architecture 502, including implementation of the methods, modules and so forth described herein.

The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular system. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine depicted in block diagram 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement methods or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660 and/or position components 662, among a wide array of other environmental sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 662 may include, for example, location sensors (for example, a Global Position System (GPS) receiver), altitude sensors (for example, an air pressure sensor from which altitude may be derived), and/or orientation sensors (for example, magnetometers). The motion components 658 may include, for example, motion sensors such as acceleration and rotation sensors. The environmental components 660 may include, for example, illumination sensors, acoustic sensors and/or temperature sensors.

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 662, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-6) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:

Item 1. A data processing system comprising:
a processor; and
a memory in communication with the processor, the memory comprising executable instructions that, when executed by the processor, cause the data processing system to perform functions of:
accessing a general knowledge graph, the general knowledge graph including a plurality of items of information about a plurality of general knowledge topics;
extracting a plurality of learning topics, the plurality of learning topics being topics associated with a desired learning curriculum;
identifying associations between one or more of the plurality of learning topics and one or more of the plurality of items of information in the general knowledge graph;
upon identifying the associations, utilizing the associations to create a learning graph based on at least one of the one or more of the plurality of learning topics, the one or more of the plurality of items of information and the associations between them, the learning graph being a learning knowledge visualization graph; and transmitting the learning graph to a learning application for use in providing the desired learning curriculum.

Item 2. The data processing system of item 1, wherein the learning topics are extracted from an entity-specific knowledge graph.

Item 3. The data processing system of any one of items 1 or 2, wherein the learning graph includes information about a plurality of learning graph topics and the executable instructions, when executed by the processor, further cause the data processing system to perform functions of:
creating a summary for one or more of the plurality of learning graph topics; and
providing the summary to the learning application.

Item 4. The data processing system of item 3, wherein the summary is used by the learning application to display information about a non-selected topic to a user utilizing the learning application.

Item 5. The data processing system of any of the preceding items, wherein the executable instructions, when executed by the processor, further cause the data processing system to perform functions of:
determining if a degree of association between the one of the one or more of the plurality of learning topics and the one or more of the plurality of items of information meets a required threshold before identifying the one of the one or more of the plurality of learning topics as being associated with the one or more of the plurality of items of information.

Item 6. The data processing system of any one of the preceding items, wherein the learning graph includes a plurality of nodes, each node representing a learning graph topic in the learning graph.

Item 7. The data processing system of any one of the preceding items, wherein identifying associations between one of the one or more of the plurality of learning topics and the one or more of the plurality of items of information comprises:
indexing information about the plurality of items of information in a search index;
creating a search query based on one of the plurality of learning topics;
executing the search query in the search index to determine if the search matches any entries in the search index;
upon determining that the search query matches an entry in the search index, identifying the one of the plurality of learning topics as being associated with the entry;
determining which one of the plurality of items of information is related the entry; and
identifying the item of information related with the entry as being associated with the one of the plurality of learning topics.

Item 8. A method for creating a learning graph, comprising:
accessing a general knowledge graph, the general knowledge graph including a plurality of items of information about a plurality of general knowledge topics;
extracting a plurality of learning topics, the plurality of learning topics being topics associated with a desired learning curriculum;
identifying associations between one or more of the plurality of learning topics and one or more of the plurality of items of information in the general knowledge graph;
upon identifying the associations, utilizing the associations to create the learning graph based on at least one of the one or more of the plurality of learning topics, the one or more of the plurality of items of information and the associations between them, the learning graph being a learning knowledge visualization graph; and
transmitting the learning graph to a learning application for use in providing the desired learning curriculum.

Item 9. The method of item 8, wherein the learning graph includes information about a plurality of learning graph topics, the method further comprising:
creating a summary for one or more of the plurality of learning graph topics; and
providing the summary to the learning application.

Item 10. The method of item 9, wherein the summary is used by the learning application to display information about a non-selected topic to a user utilizing the learning application.

Item 11. The method of any of items 8-10, further comprising determining if a degree of association between the one of the one or more of the plurality of learning topics and the one or more of the plurality of items of information meets a required threshold before identifying the one of the one or more of the plurality of learning topics as being associated with the one or more of the plurality of items of information.

Item 12. The method of any of items 8-11, wherein the learning curriculum provides guided graph navigation to guide a user through user-customized graph walks.

Item 13. The method of any of items 8-12, wherein identifying associations between one of the one or more of the plurality of learning topics and the one or more of the plurality of items of information comprises:
indexing information about the plurality of items of information in a search index;
creating a search query based on one of the plurality of learning topics;
executing the search query in the search index to determine if the search matches any entries in the search index;
upon determining that the search query matches an entry in the search index, identifying the one of the plurality of learning topics as being associated with the entry;
determining which one of the plurality of items of information is related the entry; and
identifying the item of information related with the entry as being associated with the one of the plurality of learning topics.

Item 14. A non-transitory computer readable medium on which are stored instructions that, when executed, cause a programmable device to:
access a general knowledge graph, the general knowledge graph including a plurality of items of information about a plurality of general knowledge topics;
extract a plurality of learning topics, the plurality of learning topics being topics associated with a desired learning curriculum;
identify associations between one or more of the plurality of learning topics and one or more of the plurality of items of information in the general knowledge graph;
upon identifying the associations, utilize the associations to create a learning graph based on at least one of the one or more of the plurality of learning topics, the one or more of the plurality of items of information and the associations between them, the learning graph being a learning knowledge visualization graph; and
transmit the learning graph to a learning application for use in providing the desired learning curriculum.

Item 15. The non-transitory computer readable medium of item 14, wherein the general knowledge graph is a general taxonomy.

Item 16. The non-transitory computer readable medium of item 14 or 15, wherein the learning graph includes information about a plurality of learning graph topics and the instructions when executed further cause a programmable device to:
create a summary for one or more of the plurality of learning graph topics; and
provide the summary to the learning application.

Item 17. The non-transitory computer readable medium of item 16, wherein the summary is used by the learning application to display information about a non-selected topic to a user utilizing the learning application.

Item 18. The non-transitory computer readable medium of any of items 14-17, wherein the instructions when executed further cause a programmable device to determine if a degree of association between the one of the one or more of the plurality of learning topics and the one or more of the plurality of items of information meets a required threshold before identifying the one of the one or more of the plurality of learning topics as being associated with the one or more of the plurality of items of information.

Item 19. The non-transitory computer readable medium of any of items 14-18, wherein the learning graph includes a plurality of nodes, each node representing a topic in the learning graph.

Item 20. The non-transitory computer readable medium of any of items 14-19, wherein identifying associations between one of the one or more of the plurality of learning topics and the one or more of the plurality of items of information comprises:
indexing information about the plurality of items of information in a search index;
creating a search query based on one of the plurality of learning topics;
executing the search query in the search index to determine if the search matches any entries in the search index;
upon determining that the search query matches an entry in the search index, identifying the one of the plurality of learning topics as being associated with the entry;
determining which one of the plurality of items of information is related the entry; and
identifying the item of information related with the entry as being associated with the one of the plurality of learning topics.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory comprising executable instructions that, when executed by the processor, cause the data processing system to perform functions of:
accessing a general knowledge graph, the general knowledge graph including a plurality of items of information about a plurality of general knowledge topics;
extracting a plurality of learning topics, the plurality of learning topics being topics associated with a desired learning curriculum;
identifying associations between one or more of the plurality of learning topics and one or more of the plurality of items of information in the general knowledge graph;
upon identifying the associations, utilizing the associations to create a learning graph based on at least one of the one or more of the plurality of learning topics, the one or more of the plurality of items of information and the associations between them, the learning graph being a learning knowledge visualization graph; and
transmitting the learning graph to a learning application for use in providing the desired learning curriculum.

2. The data processing system of claim 1, wherein the learning topics are extracted from an entity-specific knowledge graph.

3. The data processing system of claim 1, wherein the learning graph includes information about a plurality of learning graph topics and the executable instructions, when executed by the processor, further cause the data processing system to perform functions of:
creating a summary for one or more of the plurality of learning graph topics; and
providing the summary to the learning application.

4. The data processing system of claim 3, wherein the summary is used by the learning application to display information about a non-selected topic to a user utilizing the learning application.

5. The data processing system of claim 1, wherein the executable instructions, when executed by the processor, further cause the data processing system to perform functions of:
determining if a degree of association between the one of the one or more of the plurality of learning topics and the one or more of the plurality of items of information meets a required threshold before identifying the one of the one or more of the plurality of learning topics as being associated with the one or more of the plurality of items of information.

6. The data processing system of claim 1, wherein the learning graph includes a plurality of nodes, each node representing a learning graph topic in the learning graph.

7. The data processing system of claim 1, wherein identifying associations between one of the one or more of the plurality of learning topics and the one or more of the plurality of items of information comprises:
indexing information about the plurality of items of information in a search index;
creating a search query based on one of the plurality of learning topics;
executing the search query in the search index to determine if the search matches any entries in the search index;
upon determining that the search query matches an entry in the search index, identifying the one of the plurality of learning topics as being associated with the entry;
determining which one of the plurality of items of information is related the entry; and
identifying the item of information related with the entry as being associated with the one of the plurality of learning topics.

8. A method for creating a learning graph, comprising:
accessing a general knowledge graph, the general knowledge graph including a plurality of items of information about a plurality of general knowledge topics;
extracting a plurality of learning topics, the plurality of learning topics being topics associated with a desired learning curriculum;
identifying associations between one or more of the plurality of learning topics and one or more of the plurality of items of information in the general knowledge graph;
upon identifying the associations, utilizing the associations to create the learning graph based on at least one of the one or more of the plurality of learning topics, the one or more of the plurality of items of information and the associations between them, the learning graph being a learning knowledge visualization graph; and
transmitting the learning graph to a learning application for use in providing the desired learning curriculum.

9. The method of claim 8, wherein the learning graph includes information about a plurality of learning graph topics, the method further comprising:
creating a summary for one or more of the plurality of learning graph topics; and
providing the summary to the learning application.

10. The method of claim 9, wherein the summary is used by the learning application to display information about a non-selected topic to a user utilizing the learning application.

11. The method of claim 8, further comprising determining if a degree of association between the one of the one or more of the plurality of learning topics and the one or more of the plurality of items of information meets a required threshold before identifying the one of the one or more of the plurality of learning topics as being associated with the one or more of the plurality of items of information.

12. The method of claim 8, wherein the learning curriculum provides guided graph navigation to guide a user through user-customized graph walks.

13. The method of claim 8, wherein identifying associations between one of the one or more of the plurality of learning topics and the one or more of the plurality of items of information comprises:
indexing information about the plurality of items of information in a search index;
creating a search query based on one of the plurality of learning topics;
executing the search query in the search index to determine if the search matches any entries in the search index;
upon determining that the search query matches an entry in the search index, identifying the one of the plurality of learning topics as being associated with the entry;
determining which one of the plurality of items of information is related the entry; and
identifying the item of information related with the entry as being associated with the one of the plurality of learning topics.

14. A non-transitory computer readable medium on which are stored instructions that, when executed, cause a programmable device to:
access a general knowledge graph, the general knowledge graph including a plurality of items of information about a plurality of general knowledge topics;
extract a plurality of learning topics, the plurality of learning topics being topics associated with a desired learning curriculum;
identify associations between one or more of the plurality of learning topics and one or more of the plurality of items of information in the general knowledge graph;
upon identifying the associations, utilize the associations to create a learning graph based on at least one of the one or more of the plurality of learning topics, the one or more of the plurality of items of information and the associations between them, the learning graph being a learning knowledge visualization graph; and
transmit the learning graph to a learning application for use in providing the desired learning curriculum.

15. The non-transitory computer readable medium of claim 14, wherein the general knowledge graph is a general taxonomy.

16. The non-transitory computer readable medium of claim 14, wherein the learning graph includes information about a plurality of learning graph topics and the instructions when executed further cause a programmable device to:
create a summary for one or more of the plurality of learning graph topics; and
provide the summary to the learning application.

17. The non-transitory computer readable medium of claim 16, wherein the summary is used by the learning application to display information about a non-selected topic to a user utilizing the learning application.

18. The non-transitory computer readable medium of claim 14, wherein the instructions when executed further cause a programmable device to determine if a degree of association between the one of the one or more of the plurality of learning topics and the one or more of the plurality of items of information meets a required threshold before identifying the one of the one or more of the plurality of learning topics as being associated with the one or more of the plurality of items of information.

19. The non-transitory computer readable medium of claim 14, wherein the learning graph includes a plurality of nodes, each node representing a topic in the learning graph.

20. The non-transitory computer readable medium of claim 14, wherein identifying associations between one of the one or more of the plurality of learning topics and the one or more of the plurality of items of information comprises:
indexing information about the plurality of items of information in a search index;
creating a search query based on one of the plurality of learning topics;
executing the search query in the search index to determine if the search matches any entries in the search index;
upon determining that the search query matches an entry in the search index, identifying the one of the plurality of learning topics as being associated with the entry;
determining which one of the plurality of items of information is related the entry; and
identifying the item of information related with the entry as being associated with the one of the plurality of learning topics.
